(19) United States
(12) Patent Application Publication
(10) Pub. No.: US 2024/0212392 A1
(43) Pub. Date: Jun. 27, 2024

(54) DETERMINING INCONSISTENCY OF LOCAL MOTION TO DETECT EDITED VIDEO

(71) Applicant: Tencent Technology (Shenzhen) Company Limited, Shenzhen (CN)

(72) Inventors: Zhihao GU, Shenzhen (CN); Taiping YAO, Shenzhen (CN); Yang CHEN, Shenzhen (CN); Shouhong DING, Shenzhen (CN)

(73) Assignee: Tencent Technology (Shenzhen) Company Limited, Shenzhen (CN)

(21) Appl. No.: 18/593,523

(22) Filed: Mar. 1, 2024

Related U.S. Application Data
(63) Continuation of application No. PCT/CN2023/121724, filed on Sep. 26, 2023.

(30) Foreign Application Priority Data
Oct. 20, 2022 (CN) 202211289026.3

(51) Int. Cl. G06V 40/40; G06V 10/77; G06V 10/82; G06V 20/40; G06V 40/16

(52) U.S. Cl. CPC G06V 40/40; G06V 10/7715; G06V 10/82; G06V 20/41; G06V 20/46; G06V 40/161

(57) ABSTRACT

A video detection method includes extracting N video snippets from a video, each video snippet of the N video snippets comprising M frames, and determining a probability that an initial object in the video is an edited object. The probability is determined based on intra-snippet representation vectors and inter-snippet representation vectors, each intra-snippet representation vector corresponding to a respective video snippet of the N video snippets and representing inconsistent information between frames in the respective video snippet of the N video snippets, and each inter-snippet representation vector corresponding to a respective video snippet of the N video snippets and representing inconsistent information between the respective video snippet and one or more adjacent video snippets of the N video snippets.

### RELATED APPLICATIONS

This application is a continuation of International Application No. PCT/CN2023/121724, filed on Sep. 26, 2023, which claims priority to Chinese Patent Application No. 202211289026.3, entitled “VIDEO DETECTION METHOD AND APPARATUS, STORAGE MEDIUM, AND ELECTRONIC DEVICE” and filed on Oct. 20, 2022. The disclosures of the prior applications are hereby incorporated by reference in their entirety.

### FIELD OF THE TECHNOLOGY

This application relates to the field of computers, including a video detection method and apparatus, a storage medium, and an electronic device.

### BACKGROUND OF THE DISCLOSURE

With the rapid development of video editing technologies, videos generated by using technologies such as deepfake are spread on social media. However, the deepfake technology causes a certain problem in fields such as face verification, and whether a video is edited needs to be determined. At present, related methods are mainly divided into two categories: 1) an image-based face editing detection method; and 2) a video-based face editing detection method.

The image-based detection method performs editing detection by mining discriminative features at a frame level. However, with the development of editing technologies, forgery traces at the frame level can be hardly caught, making it difficult to maintain high accuracy during video detection. In the related video-based face editing detection method, video face editing detection is regarded as a video-level representation learning problem. Only long-term inconsistency is modeled and short-term inconsistency is completely ignored, which results in low accuracy in detecting whether an object in a video is edited.

### SUMMARY

Embodiments of this application provide a video detection method and apparatus, a storage medium, and an electronic device, so as to resolve at least a technical problem of relatively low accuracy in detecting whether an object in a video is edited in the related art.

In an embodiment, a video detection method includes extracting N video snippets from a video, each video snippet of the N video snippets comprising M frames. The N video snippets include an initial object, and both N and M are positive integers greater than or equal to 2. The method further includes determining a representation vector of the N video snippets, and determining a recognition result based on the representation vector, the recognition result representing a probability that the initial object is an edited object. The representation vector is determined based on intra-snippet representation vectors and inter-snippet representation vectors, each intra-snippet representation vector corresponding to a respective video snippet of the N video snippets and representing inconsistent information between frames in the respective video snippet of the N video snippets. Each inter-snippet representation vector corresponds to a respective video snippet of the N video snippets and represents inconsistent information between the respective video snippet and one or more adjacent video snippets of the N video snippets.

In an embodiment, a video detection apparatus includes processing circuitry configured to extract N video snippets from a video, each video snippet of the N video snippets comprising M frames. The N video snippets include an initial object, and both N and M are positive integers greater than or equal to 2. The processing circuitry is further configured to determine a representation vector of the N video snippets, and determine a target recognition result based on the representation vector, the recognition result representing a probability that the initial object is an edited object. The representation vector is determined based on intra-snippet representation vectors and inter-snippet representation vectors, each intra-snippet representation vector corresponding to a respective video snippet of the N video snippets and representing inconsistent information between frames in the respective video snippet of the N video snippets. Each inter-snippet representation vector corresponds to a respective video snippet of the N video snippets and represents inconsistent information between the respective video snippet and one or more adjacent video snippets of the N video snippets.

In an embodiment, a video detection apparatus includes processing circuitry configured to extract N video snippets from a video, each video snippet of the N video snippets comprising M frames. The N video snippets include an initial object, and both N and M are positive integers greater than or equal to 2. The apparatus further includes a neural network model configured to obtain a recognition result based on the N video snippets, the recognition result representing a probability that the initial object is an edited object. The neural network model includes a backbone network and a classification network, the backbone network being configured to determine a representation vector of the N video snippets, and the classification network being configured to determine the recognition result based on the representation vector. The backbone network includes an intra-snippet recognition module and an inter-snippet recognition module, the intra-snippet recognition module being configured to determine intra-snippet representation vectors, each corresponding to a respective video snippet of the N video snippets and representing inconsistent information between frames in the respective video snippet of the N video snippets. The inter-snippet recognition module is configured to determine inter-snippet representation vectors, each corresponding to a respective video snippet of the N video snippets and representing inconsistent information between the respective video snippet and one or more adjacent video snippets of the N video snippets. The representation vector is based on the intra-snippet representation vectors and the inter-snippet representation vectors.

By mining local motion and providing a new sampling unit “video snippet sampling”, inconsistency of the local motion is modeled, and an intra-snippet recognition module and an inter-snippet recognition module are used to establish a dynamic inconsistency model to obtain short-term motion inside each video snippet. Next, information exchange across video snippets is obtained to form a global representation, and the global recognition can be plugged-and-played into a convolutional neural network, so that an effect of detecting whether an object in a video is edited may be optimized, and accuracy in detecting whether the object in the video is edited may be improved.

### BRIEF DESCRIPTION OF THE DRAWINGS

The accompanying drawings described herein are used for providing a further understanding of this disclosure, and form part of this disclosure. Exemplary embodiments of this disclosure and descriptions thereof are used for explaining this disclosure, and do not constitute any inappropriate limitation to this disclosure. In the accompanying drawings:

FIG. 1 is a schematic diagram of an application environment of a video detection method according to an embodiment of this disclosure.

FIG. 2 is a schematic flowchart of a video detection method according to an embodiment of this disclosure.

FIG. 3 is a schematic diagram of a video detection method according to an embodiment of this disclosure.

FIG. 4 is a schematic diagram of still another video detection method according to an embodiment of this disclosure.

FIG. 5 is a schematic diagram of still another video detection method according to an embodiment of this disclosure.

FIG. 6 is a schematic diagram of still another video detection method according to an embodiment of this disclosure.

FIG. 7 is a schematic diagram of still another video detection method according to an embodiment of this disclosure.

FIG. 8 is a schematic diagram of still another video detection method according to an embodiment of this disclosure.

FIG. 9 is a schematic diagram of still another video detection method according to an embodiment of this disclosure.

FIG. 10 is a schematic structural diagram of a video detection apparatus according to an embodiment of this disclosure.

FIG. 11 is a schematic structural diagram of a video detection product according to an embodiment of this disclosure.

FIG. 12 is a schematic structural diagram of an electronic device according to an embodiment of this disclosure.

### DESCRIPTION OF EMBODIMENTS

To make a person skilled in the art better understand solutions of this disclosure, the technical solutions in the embodiments of this disclosure are clearly and completely described below with reference to the accompanying drawings in the embodiments of this disclosure. Apparently, the described embodiments are merely some rather than all of the embodiments of this disclosure. All other embodiments obtained by a person of ordinary skill in the art based on the embodiments of this disclosure without creative efforts shall fall within the protection scope of this disclosure.

In the specification, claims, and accompanying drawings of this disclosure, the terms “first”, “second”, and the like are intended to distinguish between similar objects but do not necessarily indicate a specific order or sequence. It is to be understood that the data used in such a way is interchangeable in proper circumstances, so that the embodiments of this disclosure described herein can be implemented in other orders than the order illustrated or described herein. In addition, the terms “comprise”, “include”, and any other variants thereof mean to cover non-exclusive inclusion. For example, a process, method, system, product, or device that includes a series of steps or units is not necessarily limited to those expressly listed steps or units, but may include other steps or units not expressly listed or inherent to the process, method, product, or device.

First, some terms appearing in the description of the embodiments of this disclosure are explained as follows:
DeepFake: face forging;
Snippet: a video snippet including a small quantity of video frames;
Intra-SIM: an intra-snippet inconsistency module;
Inter-SIM: an inter-snippet inconsistency module.

This disclosure is described below with reference to the embodiments:

According to an aspect of the embodiments of this disclosure, a video detection method is provided. In this embodiment, the foregoing video detection method may be applied to a hardware environment including a server 101 and a terminal device 103 that is shown in FIG. 1. As shown in FIG. 1, the server 101 is connected to the terminal 103 through a network and may be configured to provide a service for the terminal device or an application program installed on the terminal device. The application program may be a video application program, an instant messaging application program, a browser application program, an education application program, a game application program, or the like. A database 105 may be arranged on or independent of the server, and may be configured to provide a data storage service for the server 101, such as a video data storage server. The network includes, but not limited to: a wired network and a wireless network. The wired network includes: a local area network, a metropolitan area network, and a wide area network. The wireless network includes: Bluetooth, WiFi, and another network implementing wireless communication. The terminal device 103 may be a terminal configured with an application program, and may include, but not limited to, at least one of the following: a computer device such as a mobile phone (for example, an Android mobile phone, or an iOS mobile phone), a notebook computer, a tablet computer, a palmtop computer, a mobile Internet device (MID), a PAD, a desktop computer, and a smart TV. The foregoing server may be a single server, a server cluster that includes a plurality of servers, or a cloud server.

With reference to FIG. 1, the foregoing video detection method may be implemented on the terminal device 103 through the following steps:
S1: Extract N video snippets from a to-be-processed video, where each video snippet in the N video snippets includes M frames of images, the N video snippets include a to-be-recognized initial object, and both N and M are positive integers greater than or equal to 2.
S2: Determine a target representation vector of the N video snippets based on the N video snippets, and determine a target recognition result based on the target representation vector, where the target recognition result represents a probability that the initial object is an edited object.

The target representation vector is a representation vector determined based on an intra-snippet representation vector and an inter-snippet representation vector, the intra-snippet representation vector is determined by a first representation vector, the first representation vector is an intermediate representation vector corresponding to each video snippet in the N video snippets, the intra-snippet representation vector is configured for representing inconsistent information between frames of images in each video snippet in the N video snippets, the inter-snippet representation vector is determined by a second representation vector, the second representation vector is an intermediate representation vector corresponding to each video snippet in the N video snippets, and the inter-snippet representation vector is configured for representing inconsistent information between the N video snippets.

In this embodiment, the foregoing video detection method may alternatively be implemented through a server, for example, implemented in the server 101 shown in FIG. 1; or jointly implemented by a user terminal and a server.

The foregoing is only an example and is not limited in this embodiment.

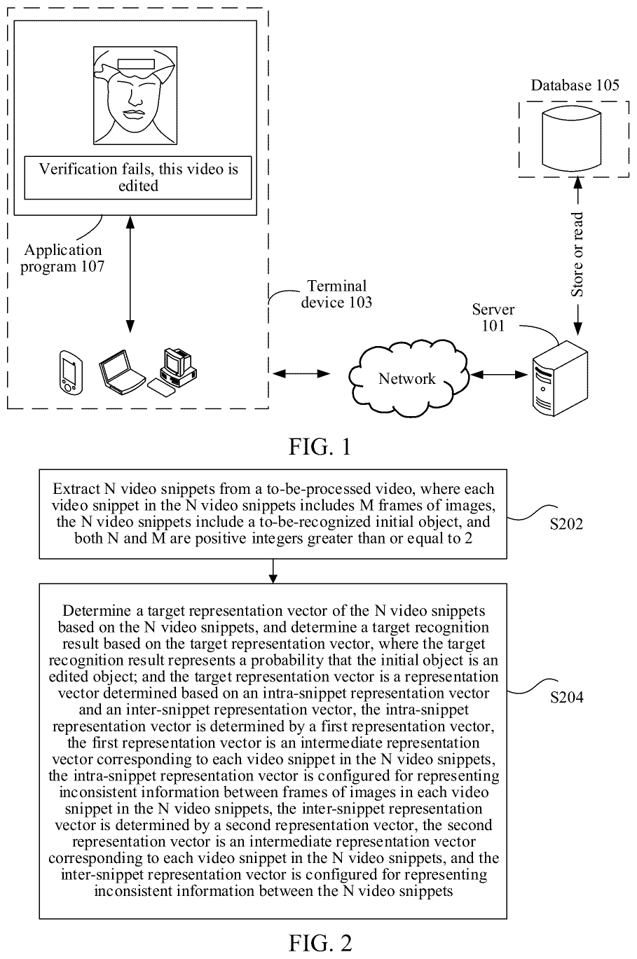

In an implementation, as shown in FIG. 2, the video detection method includes the following steps:
S202: Extract N video snippets from a to-be-processed video, where each video snippet in the N video snippets includes M frames of images, the N video snippets include a to-be-recognized initial object, and both N and M are positive integers greater than or equal to 2. For example, N video snippets are extracted from a video, each video snippet of the N video snippets comprising M frames. The N video snippets include an initial object, and both N and M are positive integers greater than or equal to 2.

In this embodiment, the foregoing to-be-processed video may include, but not limited to, a video including a to-be-recognized initial object. The extracting N video snippets from a to-be-processed video may be understood as sampling several frames of images from the video at equal intervals by using a sampling tool. Then, a region in which the foregoing initial object is located is framed through a detection algorithm, and magnification is performed by using the frame as a center region by a predetermined multiple and cropping is then performed, so that a cropping result includes the initial object and a part of a background region around the initial object. If a plurality of initial objects are detected in a same frame of image, the method may include, but not limited to, directly saving all the initial objects as the to-be-recognized initial object.

In this embodiment, the foregoing to-be-processed video may be divided into N video snippets and extraction is performed on the N video snippets. A certain quantity of frames of images are allowed between video snippets in the foregoing N video snippets. The M frames of images included in each video snippet in the foregoing N video snippets are continuous, and a frame of image is not allowed to be separated between frames of images.

For example, the to-be-processed video is divided into a snippet A, a snippet B, and a snippet C, where the snippet A and the snippet B are separated by 20 frames of images, and the snippet B and the snippet C are separated by 5 frames of images. The snippet A includes frames of images from a 1^{st} frame of image to a 5^{th} frame of image, the snippet B includes frames of images from a 26^{th} frame of image to a 30^{th} frame of image, and the snippet C includes frames of images from a 36^{th} frame of image to a 40^{th} frame of image.
S204: Determine a target representation vector of the N video snippets based on the N video snippets, and determine a target recognition result based on the target representation vector, where the target recognition result represents a probability that the initial object is an edited object. For example, a representation vector of the N video snippets is determined, and a recognition result is determined based on the representation vector, the recognition result representing a probability that the initial object is an edited object.

The target representation vector is a representation vector determined based on an intra-snippet representation vector and an inter-snippet representation vector, the intra-snippet representation vector is determined by a first representation vector, the first representation vector is an intermediate representation vector corresponding to each video snippet in the N video snippets, the intra-snippet representation vector is configured for representing inconsistent information between frames of images in each video snippet in the N video snippets, the inter-snippet representation vector is determined by a second representation vector, the second representation vector is an intermediate representation vector corresponding to each video snippet in the N video snippets, and the inter-snippet representation vector is configured for representing inconsistent information between the N video snippets. For example, the representation vector is determined based on intra-snippet representation vectors and inter-snippet representation vectors, each intra-snippet representation vector corresponding to a respective video snippet of the N video snippets and representing inconsistent information between frames in the respective video snippet of the N video snippets. Each inter-snippet representation vector corresponds to a respective video snippet of the N video snippets and represents inconsistent information between the respective video snippet and one or more adjacent video snippets of the N video snippets.

That the foregoing target recognition result represents a probability that the initial object is an edited object may be understood as a probability that the foregoing to-be-processed video is an edited video or a probability that the initial object in the foregoing to-be-processed video is an edited object.

In an exemplary embodiment, the foregoing video detection method may be applied, but not limited to, to a model having the following structure:
an extraction module, configured to extract N video snippets from a to-be-processed video, where each video snippet in the N video snippets includes M frames of images, the N video snippets include a to-be-recognized initial object, and both N and M are positive integers greater than or equal to 2; and
a target neural network model, configured to obtain a target recognition result based on the inputted N video snippets, where the target recognition result represents a probability that the initial object is an edited object, the target neural network model includes a target backbone network and a target classification network, the target backbone network is configured to determine a target representation vector of the N video snippets based on the inputted N video snippets, and the target classification network is configured to determine the target recognition result based on the target representation vector.

The target backbone network includes an intra-snippet recognition module and an inter-snippet recognition module, the intra-snippet recognition module is configured to determine an intra-snippet representation vector based on a first representation vector inputted to the intra-snippet recognition module, the first representation vector is an intermediate representation vector corresponding to each video snippet in the N video snippets, the intra-snippet representation vector is configured for representing inconsistent information between frames of images in cach video snippet in the N video snippets, the inter-snippet recognition module is configured to determine an inter-snippet representation vector based on a second representation vector inputted to the inter-snippet recognition module, the second representation vector is an intermediate representation vector corresponding to each video snippet in the N video snippets, the inter-snippet representation vector is configured for representing inconsistent information between the N video snippets, and the target representation vector is a representation vector determined based on the intra-snippet representation vector and the inter-snippet representation vector.

The foregoing model further includes: an obtaining module, configured to obtain original representation vectors of the N video snippets; a first network structure, configured to determine the first representation vector inputted to the intra-snippet recognition module based on the original representation vectors; the intra-snippet recognition module, configured to determine the intra-snippet representation vector based on the first representation vector; a second network structure, configured to determine the second representation vector inputted to the inter-snippet recognition module based on the original representation vectors; the inter-snippet recognition module, configured to determine the inter-snippet representation vector based on the second representation vector; and a third network structure, configured to determine the target representation vector based on the intra-snippet representation vector and the inter-snippet representation vector.

In an exemplary embodiment, the foregoing target backbone network includes the intra-snippet recognition module and the inter-snippet recognition module that are alternately placed.

In this embodiment, the foregoing target neural network model may include, but not limited to, a model that includes the target backbone network and the target classification network. The foregoing target backbone network is configured to determine the target representation vector representing the foregoing inputted video snippets, and the foregoing target classification network is configured to determine the foregoing target recognition result based on the target representation vector.

The foregoing target neural network model may be deployed on a server, or may be deployed on a terminal device, or may be deployed on a server for training and deployed on a terminal device for application and testing.

In this embodiment, the foregoing target neural network model may be a neural network model trained and used based on an artificial intelligence technology. Artificial intelligence (AI) is a theory, method, technology, and application system that uses a digital computer or a machine controlled by a digital computer to simulate, extend, and expand human intelligence, perceive an environment, obtain knowledge, and use knowledge to obtain an optimal result. In other words, the AI is a comprehensive technology in computer science and attempts to understand the essence of intelligence and produce a new intelligent machine that can react in a manner similar to human intelligence. The AI is to study design principles and implementation methods of various intelligent machines, to enable the machines to have functions of perception, reasoning, and decision-making.

The AI technology is a comprehensive discipline, relating to a wide range of fields, and involving both a hardware-level technology and a software-level technology. Basic AI technologies generally include technologies such as a sensor, a dedicated AI chip, cloud computing, distributed storage, a big data processing technology, an operating/interaction system, and electromechanical integration. AI software technologies mainly include several major directions such as a computer vision technology, a speech processing technology, a natural language processing technology, and machine learning/deep learning.

Computer vision (CV) is a scientific field that studies how to enable a machine to “sec”, and to be specific, to implement machine vision such as recognition and measurement for a target by using a camera and a computer in replacement of human eyes, and further perform graphic processing, so that the computer processes the target into an image more suitable for human eyes to observe, or more suitable to be transmitted to an instrument for detection. As a scientific discipline, the CV studies related theories and technologies in an attempt to establish an AI system that can obtain information from images or multidimensional data. The CV technology generally includes technologies such as image processing, image recognition, image semantic understanding, image retrieval, optical character recognition (OCR), video processing, video semantic understanding, video content/behavior recognition, 3D object reconstruction, a 3D technology, virtual reality, augmented reality, synchronous positioning, and map construction, and further include biometric feature recognition technologies such as common face recognition and fingerprint recognition.

Machine learning (ML) is a multi-field interdiscipline and relates to a plurality of disciplines such as the probability theory, statistics, the approximation theory, convex analysis, and the algorithm complexity theory. The ML specializes in studying how a computer simulates or implements a human learning behavior to acquire new knowledge or skills, and reorganize an existing knowledge structure, so as to keep improving its performance. The ML is the core of the AI, is a basic way to make a computer intelligent, and is applied to various fields of AI. The ML and the deep learning generally include technologies such as an artificial neural network, a belief network, reinforcement learning, transfer learning, inductive learning, and learning from demonstrations.

In this embodiment, the foregoing target backbone network may include, but not limited to, a ResNet50 model, a LTSM model, and the like, to output a representation vector configured for representing the inputted video snippets. The foregoing target classification network may include, but not limited to, a binary classification model, and the like, to output a corresponding probability.

In an exemplary embodiment, the foregoing target backbone network includes an intra-snippet recognition module and an inter-snippet recognition module. The intra-snippet recognition module is configured to determine inconsistent information between frames of images in a video snippet based on the first representation vector inputted to the intra-snippet recognition module, and for example, the intra-snippet recognition module uses a bidirectional temporal difference operation and a learnable convolution to mine short-term motion in the video snippet. The inter-snippet recognition module is configured to determine inconsistent information between a video snippet and an adjacent video snippet based on the second representation vector inputted to the inter-snippet recognition module, and for example, the inter-snippet recognition module forms a global representation vector by facilitating information exchange across video snippets.

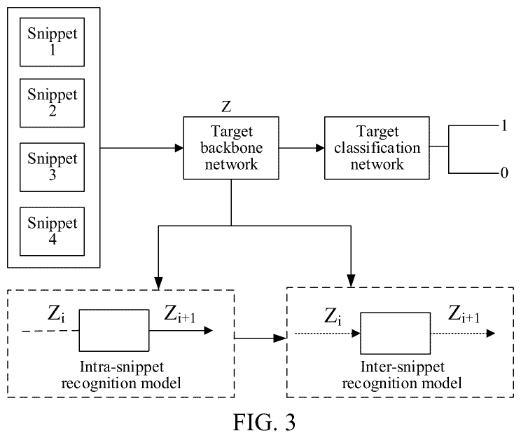

For example, FIG. 3 is a schematic diagram of a video detection method according to an embodiment of this disclosure. As shown in FIG. 3, a to-be-processed video is divided into a snippet 1, a snippet 2, a snippet 3, and a snippet 4. The snippet 1, the snippet 2, the snippet 3, and the snippet 4 are inputted to the target backbone network of the foregoing target neural network model, to respectively determine inconsistent information between adjacent frames of images in the video snippets and inconsistent information between the video snippets and adjacent video snippets through the intra-snippet recognition model and the inter-snippet recognition model, so that a probability that an initial object in the foregoing to-be-processed video is an edited object is outputted through the foregoing target classification network. Finally, the foregoing probability is compared with a preset threshold (generally 0.5) to determine whether the initial object in the foregoing to-be-processed video is an edited object. When the probability is less than the foregoing preset threshold, an output result is 1, representing that the initial object in the foregoing to-be-processed video is an edited object. When the probability is greater than or equal to the foregoing preset threshold, an output result is 0, representing that the initial object in the foregoing to-be-processed video is not an edited object.

In this embodiment, a deep face editing technology not only promotes the development of industries, but also brings a huge challenge to face verification. The foregoing video detection method may improve the security of face-based identity verification products, including businesses such as face payment and identity authentication. A powerful video screening tool may be further provided for a cloud platform to ensure the credibility of video content, so that a capability of identifying false videos is improved.

In this embodiment, for the foregoing original representation vectors, a convolution operation may be performed on the N video snippets based on a convolutional neural network to extract the foregoing original representation vectors.

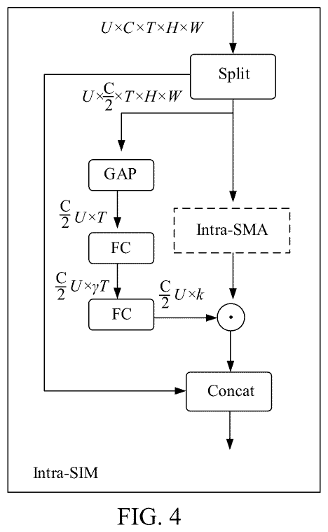

In an exemplary embodiment, FIG. 4 is a schematic diagram of another video detection method according to an embodiment of this disclosure. As shown in FIG. 4, the foregoing intra-snippet recognition model may include, but not limited to, an Intra-SIM model, and the method includes, but not limited to, the following steps:
S1: Divide a first representation vector along a channel dimension to obtain first representation sub-vectors.
S2: Determine a target convolution kernel based on the first representation sub-vectors, where the target convolution kernel is a convolution kernel corresponding to the first representation vector.
S3: Determine a target weight matrix corresponding to the first representation sub-vectors, where the target weight matrix is configured for extracting motion information between adjacent frames of images based on an attention mechanism.
S4: Determine a first target representation sub-vector based on the first representation sub-vectors, the target weight matrix, and the target convolution kernel.
S5: Splice the first representation sub-vectors and the first target representation sub-vector into an intra-snippet representation vector.

The foregoing is only an example and is not specifically limited in this embodiment.

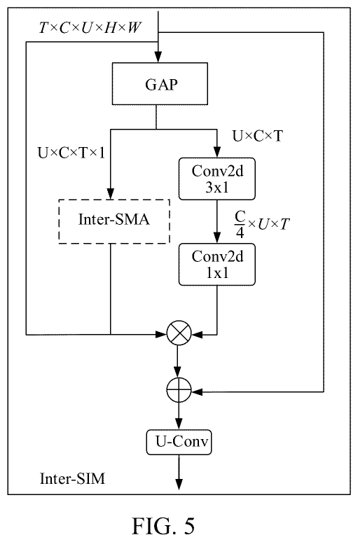

In an exemplary embodiment, FIG. 5 is a schematic diagram of still another video detection method according to an embodiment of this disclosure. As shown in FIG. 5, the foregoing intra-snippet recognition model may include, but not limited to, an Inter-SIM model, and the method includes, but not limited to, the following steps:
S1: Perform a global average pooling operation on a second representation vector to obtain a global representation vector with a compressed spatial dimension.
S2: Input the global representation vector into a pre-trained two-branch model to obtain a first global representation sub-vector and a second global representation sub-vector, where the first global representation sub-vector is configured for representing a video snippet corresponding to the second representation vector, and the second global representation sub-vector is configured for representing interaction information between the video snippet corresponding to the second representation vector and an adjacent video snippet.
S3: Determine an inter-snippet representation vector based on the global representation vector, the first global representation sub-vector, and the second global representation sub-vector.

The foregoing is only an example and is not specifically limited in this embodiment.

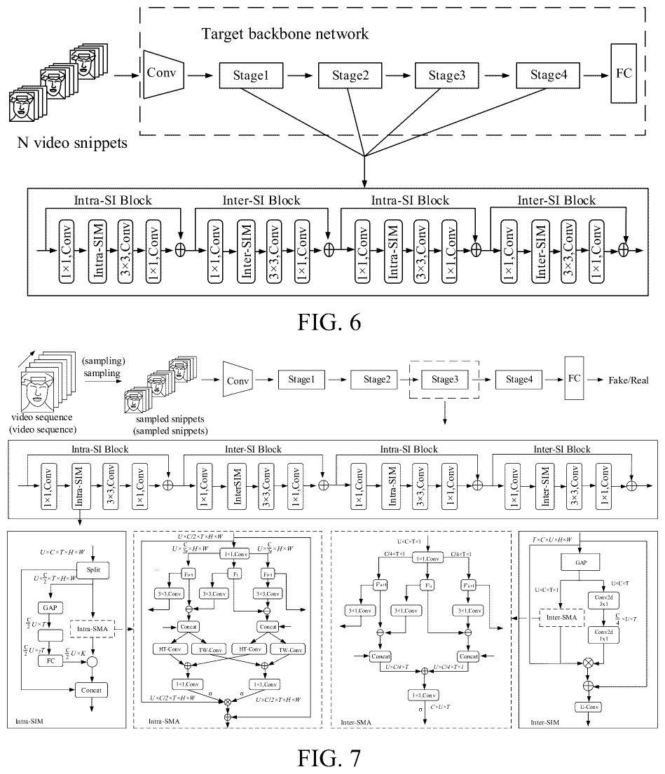

In an exemplary embodiment, FIG. 6 is a schematic diagram of still another video detection method according to an embodiment of this disclosure. As shown in FIG. 6, the foregoing target backbone network includes: a Conv convolution layer, Stage1, Stage2, Stage3, Stage4, and a FC module (a fully connected layer). A plurality of video snippets are inputted to the Conv convolution layer to first extract features, and then the features are inputted into the foregoing Stage1, Stage2, Stage3, and Stage4 sequentially. The foregoing Stage1, Stage2, Stage3, and Stage4 are each alternately deployed with an Intra-SIM and an Inter-SIM.

According to this embodiment, N video snippets are extracted from a to-be-processed video, each video snippet in the N video snippets includes M frames of images, the N video snippets include a to-be-recognized initial object, and both N and M are positive integers greater than or equal to 2; and a target representation vector of the N video snippets is determined based on the N video snippets, and a target recognition result is determined based on the target representation vector, where the target recognition result represents a probability that an initial object is an edited object. The target representation vector is a representation vector determined based on an intra-snippet representation vector and an inter-snippet representation vector, the intra-snippet representation vector is determined by a first representation vector, the first representation vector is an intermediate representation vector corresponding to each video snippet in the N video snippets, the intra-snippet representation vector is configured for representing inconsistent information between frames of images in each video snippet in the N video snippets, the inter-snippet representation vector is determined by a second representation vector, the second representation vector is an intermediate representation vector corresponding to each video snippet in the N video snippets, and the inter-snippet representation vector is configured for representing inconsistent information between the N video snippets. By mining local motion and providing a new sampling unit “video snippet sampling”, inconsistency of the local motion is modeled, and an intra-snippet recognition module and an inter-snippet recognition module are used to establish a dynamic inconsistency model to obtain short-term motion inside each video snippet. Next, information exchange across video snippets is obtained to form a global representation, and the global recognition can be plugged-and-played into a convolutional neural network, so that an effect of detecting whether an object in a video is edited may be optimized, and accuracy in detecting whether the object in the video is edited may be improved.

In an embodiment, the determining a target convolution kernel based on the first representation sub-vectors includes: performing a global average pooling operation on the first representation sub-vectors to obtain first representation sub-vectors with a compressed spatial dimension; performing a fully connected operation on the first representation sub-vectors with a compressed spatial dimension to determine an initial convolution kernel; and performing a normalization operation on the initial convolution kernel to obtain a target convolution kernel.

In this embodiment, the foregoing global average pooling operation may include, but not limited to, global average pooling (GAP), and in the foregoing GAP operation, a spatial dimension of the first representation sub-vectors may be compressed to finally obtain first representation sub-vectors with a spatial dimension of 1.

In this embodiment, the foregoing normalization operation may include, but not limited to, normalizing the initial convolution kernel into the target convolution kernel by using a softmax operation.

For example, in a learning process of a temporal convolution kernel, the global average pooling (GAP) operation is first used to compress the spatial dimension of the first representative sub-vectors to 1. Next, a convolution kernel is learned through two fully connected layers ϕ₁: R^{T}→R^{Y}^{^{T}} and ϕ₂: R^{Y}^{^{T}}→R^{k}. Finally, a softmax operation is used to normalize the convolution kernel:

$$K ( {X}_{2} ) = softmax ( {ϕ}_{1} ∘ δ ∘ {ϕ}_{2} ( GAP ( {X}_{2} ) ) ) , \qquad \# ( 4 )$$

represents function composition, and δ is a ReLU nonlinear activation function.

In an embodiment, the determining a target weight matrix corresponding to the first representation sub-vectors includes: performing a bidirectional temporal difference operation on the first representation sub-vectors to determine a first difference matrix between adjacent frames of images in a video snippet corresponding to the first representation vector; reshaping the first difference matrix into a horizontal inconsistency parameter matrix and a vertical inconsistency parameter matrix along a horizontal dimension and a vertical dimension respectively; and determining a vertical attention weight matrix and a horizontal attention weight matrix based on the horizontal inconsistency parameter matrix and the vertical inconsistency parameter matrix, where the target weight matrix includes the vertical attention weight matrix and the horizontal attention weight matrix.

In this embodiment, to model a temporal relationship, an Intra-SIMA uses bidirectional temporal difference to cause the model to focus on local motion. Assuming that I₂=[F₁, . . . , F_{T}]∈R^{C×T×H×W}, a channel is first compressed by r times, and then a first difference matrix between adjacent frames of images is calculated:

$${D}_{t , t + 1} = {F}_{t} - {Conv}_{3 \times 3} ( {F}_{t + 1} ) , \qquad \# ( 1 )$$

D_{t,t+1} represents a forward difference representation of Fₜ (corresponding to the foregoing first difference matrix), and Conv_{3×3} is a separable convolution.

In this embodiment, the method may include, but not limited to, reshaping D_{t,t+1} into

$${D}_{t , t + 1}^{h} ∈ {R}^{W \times \frac{C}{2} \times H \times T} and {D}_{t , t + 1}^{w} ∈ {R}^{H \times \frac{C}{2} \times T \times W}$$

along a width dimension and a height dimension, and then using a multi-scale structure to capture more detailed short-term motion information:

$${D}_{t , t + 1}^{H} = {Conv}_{1 \times 1} ( {Conv}_{3 \times 3} ( {D}_{t , t + 1}^{h} ) + {D}_{t , t + 1}^{h} ) , \qquad \# ( 2 )$$

$${D}_{t , t + 1}^{W} = {Conv}_{1 \times 1} ( {Conv}_{3 \times 3} ( {D}_{t , t + 1}^{w} ) + {D}_{t , t + 1}^{w} ) \qquad \# ( 3 )$$

D_{t,t+1}, D_{t,t+1}^{W}, and Conv_{1×1} respectively represent a forward vertical inconsistency parameter matrix, a forward horizontal inconsistency parameter matrix, and a 1×1 convolution. A backward vertical inconsistency parameter matrix D_{t+1,t}^{H} and a backward horizontal inconsistency parameter matrix D_{t+1,t}^{W} may be obtained through similar calculation, and then the vertical attention weight matrix and the horizontal attention weight matrix are determined based on the forward vertical inconsistency parameter matrix, the forward horizontal inconsistency parameter matrix, the backward vertical inconsistency parameter matrix, and the backward horizontal inconsistency parameter matrix.

Specifically, the method may include, but not limited to, after restoring the averaged forward inconsistency parameter matrix and the averaged backward inconsistency parameter matrix to a channel size of an original representation vector, obtaining a vertical attention Atten_{H} and a horizontal attention Atten_{W} through a sigmoid function.

In an embodiment, determining second representation sub-vectors based on the first representation sub-vectors, the target weight matrix, and the target convolution kernel includes: performing an element-wise multiplication operation on the vertical attention weight matrix, the horizontal attention weight matrix, and the first representation sub-vectors, and combining a result of the element-wise multiplication operation with the first representation sub-vectors to obtain third representation sub-vectors; and performing a convolution operation on the third representation sub-vectors by using the target convolution kernel to determine the second representation sub-vectors.

In this embodiment, the intra-snippet recognition module may be, but not limited to, modeled as:

$${O}_{2} = K ( {X}_{2} ) ⊗ ( {Atten}_{h} ⊙ {Atten}_{w} ⊙ {X}_{2} + {X}_{2} ) , \qquad \# ( 5 )$$

⊗ represents a separable convolution, and ⊙ represents element-wise multiplication. Finally, Oᵢₙₜᵣₐ=Concat[I₁, O₂] is outputted.

In an embodiment, the determining the inter-snippet representation vector based on the second representation vector includes: performing a global average pooling operation on the second representation vector to obtain a global representation vector with a compressed spatial dimension; inputting the global representation vector into a pre-trained two-branch model to obtain a first global representation sub-vector and a second global representation sub-vector, where the first global representation sub-vector is configured for representing a video snippet corresponding to the second representation vector, and the second global representation sub-vector is configured for representing interaction information between the video snippet corresponding to the second representation vector and an adjacent video snippet; and determining the inter-snippet representation vector based on the global representation vector, the first global representation sub-vector, and the second global representation sub-vector.

In this embodiment, the foregoing global average pooling operation may include, but not limited to, a global average pooling (GAP) operation, the foregoing global representation vector with a compressed spatial dimension may include, but not limited to, compressing a spatial dimension of the second representation vector to 1 to obtain the foregoing global representation vector, and the foregoing two-branch model may include, but not limited to, a corresponding model structure obtained after inputting that a GAP operation has been performed in the Inter-SIM shown in FIG. 7. The foregoing first global representation sub-vector represents an intermediate representation vector outputted by Conv2d, 1×1 on a right side, the foregoing second global representation sub-vector represents an intermediate representation vector outputted by an Inter-SMA on a left side, and the determining the inter-snippet representation vector based on the global representation vector, the first global representation sub-vector, and the second global representation sub-vector may include, but not limited to, performing a dot multiplication operation on the intermediate representation vector outputted by Conv2d, 1×1, the intermediate representation vector outputted by the Inter-SMA, and an original input (the global representation vector) shown in FIG. 7 to obtain the foregoing inter-snippet representation vector.

A combination operation may be further performed on the foregoing inter-snippet representation vector and the inputted second representation vector to obtain an inter-snippet representation vector with more details and higher-level information.

In an embodiment, the inputting the global representation vector into a pre-trained two-branch model to obtain a first global representation sub-vector and a second global representation sub-vector includes:
performing a convolution operation on the global representation vector by using a first convolution kernel to obtain a global representation vector with a reduced dimension;
performing a normalization operation on the global representation vector with a reduced dimension to obtain a normalized global representation vector;
performing a deconvolution operation on the normalized global representation vector by using a second convolution kernel to obtain the first global representation sub-vector with a same dimension as the global representation vector;
performing a bidirectional temporal difference operation on the global representation vector to determine a second difference matrix and a third difference matrix between the video snippet corresponding to the second representation vector and the adjacent video snippet; and
generating the second global representation sub-vector based on the second difference matrix and the third difference matrix.

In this embodiment, the foregoing first convolution kernel may include, but not limited to, a Conv2d convolution kernel with a size of 3×1 to perform a convolution operation on the global representation vector to obtain the global representation vector with a reduced dimension, the foregoing normalization operation may include, but not limited to, a Batch-Normal (BN) operation to obtain the normalized global representation vector, and the foregoing second convolution kernel may include, but not limited to, a Conv2d convolution kernel with a size of 1×1 to perform the foregoing deconvolution operation to obtain the foregoing first global representation sub-vector.

Specifically, this embodiment may include, but not limited to, the following formula:

$${\overline{F}}_{1} = σ ( {Conv}_{1 \times 1} ( BN ( {Conv}_{3 \times 1} ( \overline{F} ) ) ) ) , \qquad \# ( 6 )$$

F̅ represents the foregoing global representation vector, and F̅₁ represents the foregoing first global representation sub-vector.

In this embodiment, the performing a bidirectional temporal difference operation on the global representation vector to determine a second difference matrix and a third difference matrix between the video snippet corresponding to the second representation vector and the adjacent video snippet may include, but not limited to, performing a forward temporal difference operation and a reverse temporal difference operation to respectively obtain the second difference matrix and the third difference matrix.

Specifically, this embodiment may include, but not limited to, the following formula:

$${\hat{D}}_{u , u + 1} = {\hat{F}}_{u} - {Conv}_{1 \times 3} ( {\hat{F}}_{u + 1} ) , \qquad \# ( 7 )$$

$${\hat{D}}_{u + 1 , u} = {\hat{F}}_{u + 1} - {Conv}_{1 \times 3} ( {\hat{F}}_{u} ) . \qquad \# ( 8 )$$

u represents the video snippet corresponding to the second representation vector, and u+1 represents the video snippet adjacent to the video snippet corresponding to the second representation vector. In this case, \hat{D}_{u,u+1} is the foregoing second difference matrix, and \hat{D}_{u+1,u} is the foregoing third difference matrix.

The second global representation sub-vector may be determined based on, but not limited to, the following formula:

$${\overline{F}}_{2} = σ ( {Conv}_{1 \times 1} ( {\hat{D}}_{u , u + 1} + {\hat{D}}_{u + 1 , u} ) ) , \qquad \# ( 9 )$$

\hat{F}₂ represents the foregoing second global representation sub-vector, and σ represents a sigmoid activation function.

In an embodiment, the determining the inter-snippet representation vector based on the global representation vector, the first global representation sub-vector, and the second global representation sub-vector includes:
performing an element-wise multiplication operation on the first global representation sub-vector, the second global representation sub-vector, and the global representation vector, and combining a result of the element-wise multiplication operation with the global representation vector to obtain a third global representation sub-vector; and
performing a convolution operation on the third global representation sub-vector by using a third convolution kernel to determine the inter-snippet representation vector.

In this embodiment, the third global representation sub-vector may be determined based on, but not limited to, the following formula:

$${\overline{F}}_{1} ⊙ {\overline{F}}_{2} ⊙ F + F = Fv$$

Fv represents the foregoing third global representation sub-vector.

In this embodiment, the inter-snippet representation vector is determined by performing a convolution operation on the third global representation sub-vector by using the third convolution kernel, and the inter-snippet representation vector may be determined based on, but not limited to, the following formula:

$${O}_{inter} = {Conv}_{U} ( {\overline{F}}_{1} ⊙ {\overline{F}}_{2} ⊙ F + F ) , \qquad \# ( 10 )$$

Oᵢₙₜₑᵣ is the foregoing inter-snippet representation vector.

In an embodiment, the determining the target representation vector based on the intra-snippet representation vector and the inter-snippet representation vector includes:
combining the intra-snippet representation vector and the first representation vector to obtain an intermediate representation vector, where the intermediate representation vector includes the second representation vector; and
combining the intermediate representation vector and the inter-snippet representation vector to obtain the target representation vector, where the intra-snippet recognition module and the inter-snippet recognition module are alternately placed in the target neural network model.

In this embodiment, the intra-snippet recognition module and the inter-snippet recognition module are alternately placed in a neural network model. As shown in FIG. 6, the Intra-SI Block is the foregoing intra-snippet recognition module, and the Inter-SI Block is the foregoing inter-snippet recognition module. An output of each intra-snippet recognition module and an input of the intra-snippet recognition module are superimposed to be used as an input of a next connected inter-snippet recognition module, and an output of each inter-snippet recognition module and an input of the inter-snippet recognition module are superimposed to be used as an input of a next connected intra-snippet recognition module.

This disclosure is further described below with reference to a specific example:

This disclosure provides a video face-swap detection method based on dynamic inconsistency learning. A current video DeepFake detection method attempts to capture discriminative features between a real face and a fake face based on temporal modeling. However, since supervision is generally imposed on sparsely sampled frames of images, local motion between adjacent frames of images is ignored. This type of local motion includes rich inconsistency information and can be used as an effective video DeepFake detection indicator.

Therefore, model local inconsistency is performed by mining the local motion and providing a new sampling unit of snippet. In addition, a dynamic inconsistency modeling framework is established by designing an intra-snippet inconsistency module (Intra-SIM) and an inter-snippet interaction module (Inter-SIM).

Specifically, the Intra-SIM uses a bidirectional temporal difference operation and a learnable convolution to mine short-term motion in each snippet. Next, the Inter-SIM forms a global representation by facilitating inter-snippet information exchange. The two modules can be plugged-and-played into an existing 2D convolutional neural network, and basic units formed by the two modules are alternately placed. The foregoing solution has achieved leading results on four baseline data sets, and a large quantity of experiments and visualizations have further demonstrated advantages of the foregoing method.

In related application scenarios, a deep face editing technology not only promotes the development of an entertainment industry, but also brings a huge challenge to face verification. In the embodiments of this disclosure, the security of face-based identity verification products, including businesses such as face payment, and identity authentication, may be improved. In the embodiments of this disclosure, a powerful video screening tool may be further provided for a cloud platform to ensure the credibility of video content, so that a capability of identifying false videos is improved.

For example, FIG. 7 is a schematic diagram of still another video detection method according to an embodiment of this disclosure. As shown in FIG. 7, this disclosure mainly provides an Intra-SIM and an Inter-SIM. The foregoing Intra-SIM and Inter-SIM are alternately deployed in Stage1, Stage2, Stage3, and Stage4. By using Stage3 as an example, the Intra-SIM is configured to capture inconsistent information within a snippet, while the Inter-SIM is configured to promote inter-snippet information exchange. The Intra-SIM and the Inter-SIM are inserted in front of a 3×3 convolution in a basic block of ResNet-50 to respectively form an Intra-SI block and an Inter-SI block and alternately place the Intra-SI block and the Inter-SI block.

This disclosure provides the Intra-SIM to model local inconsistency included in each snippet. The Intra-SIM is a two-stream structure (a skip splicing operation is to save an original representation). The two-stream structure includes an Intra-SIM attention mechanism (Intra-SIMA) and a path having a learnable temporal convolution. Specifically, assuming that an input tensor I∈R^{C×T×H×W} represents a certain snippet, where C, T, H, W respectively represent a channel, time, a height dimension, and a width dimension. First, I is split into two parts: I₁ and I₂ along the channel, and original features are kept and inputted to the two-stream structure respectively. To model a temporal relationship, an Intra-SIMA uses bidirectional temporal difference to cause the model to focus on local motion. Assuming that I₂=[F₁, . . . , Fr] ∈R^{C×T×H×W}, a channel is first compressed by r times, and then a difference between adjacent frames of images is calculated:

$${D}_{t , t + 1} = {F}_{t} - {Conv}_{3 \times 3} ( {F}_{t + 1} ) , \qquad \# ( 1 )$$

D_{t,t+1} represents a forward difference representation of Fₜ and Conv_{3×3} is a separable convolution. Then, D_{t,t+1} is reshaped into

$${D}_{t , t + 1}^{h} ∈ {R}^{W \times \frac{C}{2} \times H \times T} and {D}_{t , t + 1}^{w} ∈ {R}^{H \times \frac{C}{2} \times T \times W}$$

along two spatial dimensions. A multi-scale structure is then used to capture more detailed short-term motion information:

$${D}_{t , t + 1}^{H} = {Conv}_{1 \times 1} ( {Conv}_{3 \times 3} ( {D}_{t , t + 1}^{h} ) + {D}_{t , t + 1}^{h} ) , \qquad \# ( 2 )$$

$${D}_{t , t + 1}^{W} = {Conv}_{1 \times 1} ( {Conv}_{3 \times 3} ( {D}_{t , t + 1}^{w} ) + {D}_{t , t + 1}^{w} ) \qquad \# ( 3 )$$

D_{t,t+1}^{H}, D_{t,t+1}^{W} and Conv_{1×1} respectively represent a forward vertical inconsistency parameter matrix, a forward horizontal inconsistency parameter matrix, and a 1×1 convolution. A backward vertical inconsistency parameter matrix D_{t+1,t}^{H} and a backward horizontal inconsistency parameter matrix D_{t+1,t}^{W} may be obtained through similar calculation. After restoring the averaged forward inconsistency parameter matrix and the averaged backward inconsistency parameter matrix to an original channel size, a vertical attention Atten_{H} and a horizontal attention Atten_{W} are obtained through a sigmoid function. In a temporal convolution learning branch, a global average pooling (GAP) operation is first performed to compress a spatial dimension to 1, then a convolution kernel is learned through two fully connected layers ϕ₁: R^{T}→R^{Y}^{^{T}} and ϕ₂: R^{Y}^{^{T}}→R^{k}, and finally a softmax operation is performed to normalize the convolution kernel:

$$K ( {X}_{2} ) = softmax ( {ϕ}_{1} ∘ δ ∘ {ϕ}_{2} ( GAP ( {X}_{2} ) ) ) , \qquad \# ( 4 )$$

represents function composition, and δ is a ReLU nonlinear activation function. Once an Intra-SIMA and a temporal convolution kernel are obtained, intra-snippet inconsistency is modeled as:

$${O}_{2} = K ( {X}_{2} ) ⊗ ( {Atten}_{h} ⊙ {Atten}_{w} ⊙ {X}_{2} + {X}_{2} ) , \qquad \# ( 5 )$$

⊗ represents a separable convolution, and ⊙ represents element-wise multiplication. Finally, an output Oᵢₙₜᵣₐ=Concat[I₁, O₂] of the module is obtained.

The Intra-SIM adaptively captures the intra-snippet inconsistency, but the Intra-SIM only includes temporal local information and ignores an inter-snippet relationship. Therefore, this disclosure designs the Inter-SIM to promote inter-snippet information exchange from a global perspective. Specifically, assuming that F∈R^{T×C×U×H×W} is an input of the Inter-SIM. First, a global representation F̅∈R^{C×U×T} is obtained through a GAP operation, and then different interaction modeling is performed through a two-branch structure. The two branches complement each other. One branch directly captures inter-snippet interaction, and no intra-snippet information is introduced.

$${\overline{F}}_{1} = σ ( {Conv}_{1 \times 1} ( BN ( {Conv}_{3 \times 1} ( \overline{F} ) ) ) ) , \qquad \# ( 6 )$$

Conv_{3×1} is a spatial convolution with a convolution kernel size 3×1. The convolution is configured for extracting a snippet-level feature and reduce a dimension. A convolution kernel of Conv_{1×1} is 1×1, which is configured for restoring a channel dimension. The other branch calculates interaction from a larger intra-snippet perspective. Assuming that \hat{\hat{F}}∈R^{r/C×U×T} is a feature obtained by F̅ through a channel dimension compressed by Conv_{1×1}, the inter-snippet interaction is first captured by Cov_{1×3}, and then similar to formula (1), and a bidirectional facial motion is modeled as:

$${\hat{D}}_{u , u + 1} = {\hat{F}}_{u} - {Conv}_{1 \times 3} ( {\hat{F}}_{u + 1} ) , \qquad \# ( 7 )$$

$${\hat{D}}_{u + 1 , u} = {\hat{F}}_{u + 1} - {Conv}_{1 \times 3} ( {\hat{F}}_{u} ) , \qquad \# ( 8 )$$

Information carrying the inter-snippet interaction is defined as:

$${\overline{F}}_{2} = σ ( {Conv}_{1 \times 1} ( {\hat{D}}_{u , u + 1} + {\hat{D}}_{u + 1 , u} ) ) . \qquad \# ( 9 )$$

Finally, a snippet after interaction is represented as:

$${O}_{inter} = {Conv}_{U} ( {\overline{F}}_{1} ⊙ {\overline{F}}_{2} ⊙ F + F ) , \qquad \# ( 10 )$$

Conv_{U} is a 2D convolution with a 3×1 kernel. Therefore, Oᵢₙₜₑᵣ can be in contact with intra-snippet information and inter-snippet information.

The video detection method may further include, but not limited to, the following content:

### 1) Data Pre-Processing Procedure:

First, OpenCV is used to sample 150 frames of images from a face video at equal intervals, and then an open source face detection algorithm MTCNN is used to frame a region in which a face is located, and multiplication is performed by using the frame as a center region by 1.2 times and cropping is performed, so that a result includes the entire face and a part of a surrounding background region. If a plurality of faces are detected in a same frame of image, all the faces are directly saved.

### Implementation Details:

S1: Construction of a training data set: For a data set with an imbalance in a quantity of fake videos and a quantity of original videos, two data generators are respectively constructed to implement a balance of categories during training.
S2: Training details: ResNet-50 is a skeleton network and a weight is pre-trained on ImageNet. The Intra-SIM and the Inter-SIM are randomly initialized and a mini-batch-based method is used. A batch size is 10, U=4 snippets are extracted respectively, and each includes T=4 frames of images for training.

A size of each frame of image of the foregoing inputted images is adjusted to 224×224, an Adam optimization algorithm is used to perform network optimization on a binary cross-entropy loss and training is performed for 30 cycles, and training is performed for 45 cycles on a cross-dataset generalization experiment. An initial learning rate is 0.0001 and decreases by one-tenth every 10 cycles. During training, the training details may include, but not limited to, performing data expansion through horizontal flipping.

Model inference: U=8 snippets are used and each snippet includes T=4 frames of images for testing. For a tested video, the tested video is first divided into 8 parts at equal intervals, and then an intermediate frame of image is extracted from each part to form a video sequence for testing the video. Next, the sequence is inputted into a pre-trained model and a probability value is obtained, which is configured for representing a probability that the video is a face-edited video (a larger probability value indicates a larger probability that a face in the video is edited).

This disclosure designs two general video face editing detection modules. The two modules can adaptively mine intra-snippet inconsistency and promote inter-snippet information exchange, thereby effectively improving the accuracy and generalization of an algorithm in a video face editing detection task.

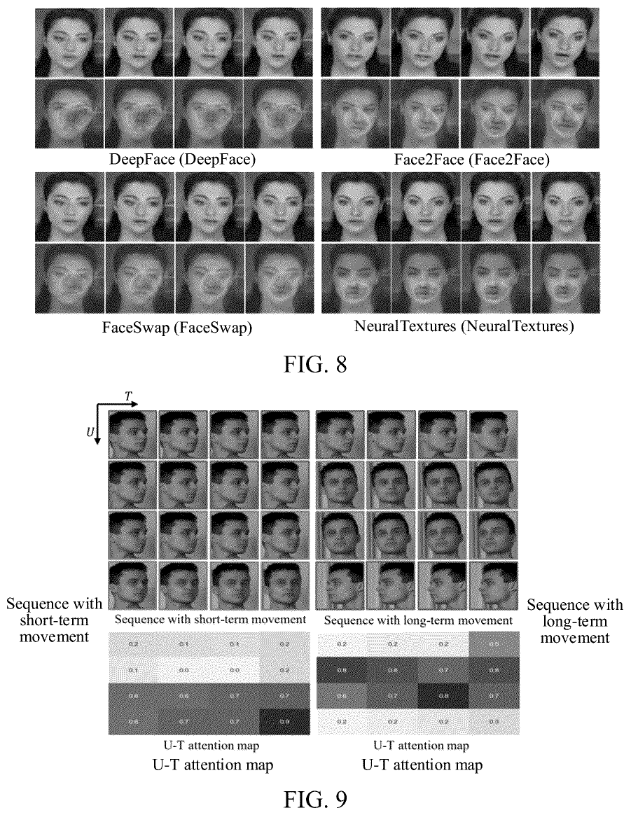

FIG. 8 is a schematic diagram of still another video detection method according to an embodiment of this disclosure. As shown in FIG. 8, although a network uses a video-level label during training, a model can still locate a forged region well for different attack types.

In addition, the method may further include, but not limited to, detecting forging in different motion states. FIG. 9 is a schematic diagram of still another video detection method according to an embodiment of this disclosure. As shown in FIG. 9, videos in a small motion amplitude and a large motion amplitude include some forged faces.

When the two videos pass through a network, U-T maps in an Inter-SIM are visualized. It can be seen that the framework provided in this disclosure can identify some forged faces.

The inter-SIM designed in this method may alternatively use another information fusion method, for example, structures such as LSTM and Self-attention.

It may be understood that, in specific implementations of this disclosure, relevant data such as user information is involved. When the foregoing embodiments of this disclosure are applied to specific products or technologies, permission or consent of a user needs to be obtained, and collection, use, and processing of the relevant data need to comply with relevant laws, regulations, and standards of relevant countries and regions.

For ease of description, the foregoing method embodiments are described as a series of action combinations. However, a person skilled in the art is to learn that this disclosure is not limited to the described action orders because some steps may be performed in another order or performed at the same time according to this disclosure. In addition, a person skilled in the art is also to learn that the embodiments described in this specification are all exemplary embodiments, and the involved actions and modules are not necessary for this disclosure.

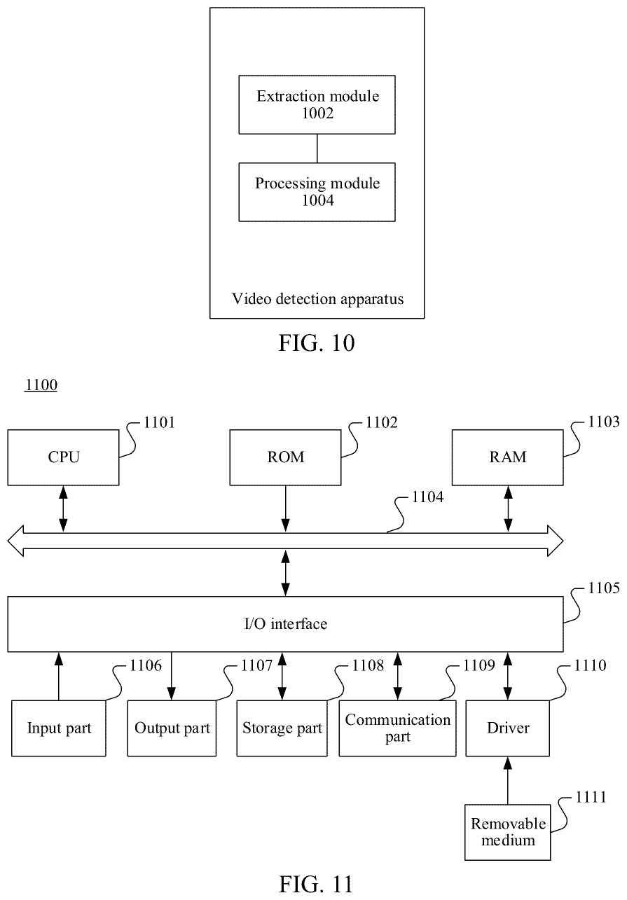

According to another aspect of the embodiments of this disclosure, a video detection apparatus for implementing the video detection method is further provided. As shown in FIG. 10, the apparatus includes:
an extraction module 1002, configured to extract N video snippets from a to-be-processed video, where each video snippet in the N video snippets includes M frames of images, the N video snippets include a to-be-recognized initial object, and both N and M are positive integers greater than or equal to 2; and
a processing module 1004, configured to determine a target representation vector of the N video snippets based on the N video snippets, and determine a target recognition result based on the target representation vector, where the target recognition result represents a probability that the initial object is an edited object. The target representation vector is a representation vector determined based on an intra-snippet representation vector and an inter-snippet representation vector, the intra-snippet representation vector is determined by a first representation vector, the first representation vector is an intermediate representation vector corresponding to each video snippet in the N video snippets, the intra-snippet representation vector is configured for representing inconsistent information between frames of images in each video snippet in the N video snippets, the inter-snippet representation vector is determined by a second representation vector, the second representation vector is an intermediate representation vector corresponding to each video snippet in the N video snippets, and the inter-snippet representation vector is configured for representing inconsistent information between the N video snippets.

In a solution, the apparatus is further configured to: divide the first representation vector along a channel dimension to obtain first representation sub-vectors; determine a target convolution kernel based on the first representation sub-vectors, where the target convolution kernel is a convolution kernel corresponding to the first representation vector; determine a target weight matrix corresponding to the first representation sub-vectors, where the target weight matrix is configured for extracting motion information between adjacent frames of images based on an attention mechanism; determine a first target representation sub-vector based on the first representation sub-vectors, the target weight matrix, and the target convolution kernel; and splice the first representation sub-vector and the first target representation sub-vector into an intra-snippet representation vector.

In a solution, the apparatus is configured to determine the target convolution kernel based on the first representation sub-vectors in the following manner: performing a global average pooling operation on the first representation sub-vectors to obtain first representation sub-vectors with a compressed spatial dimension; performing a fully connected operation on the first representation sub-vectors with a compressed spatial dimension to determine an initial convolution kernel; and performing a normalization operation on the initial convolution kernel to obtain a target convolution kernel.

In a solution, the apparatus is configured to determine the target weight matrix corresponding to the first representation sub-vectors in the following manner: performing a bidirectional temporal difference operation on the first representation sub-vectors to determine a first difference matrix between adjacent frames of images in a video snippet corresponding to the first representation vector; reshaping the first difference matrix into a horizontal inconsistency parameter matrix and a vertical inconsistency parameter matrix along a horizontal dimension and a vertical dimension respectively; and determining a vertical attention weight matrix and a horizontal attention weight matrix based on the horizontal inconsistency parameter matrix and the vertical inconsistency parameter matrix, where the target weight matrix includes the vertical attention weight matrix and the horizontal attention weight matrix.

In a solution, the apparatus is configured to determine second representation sub-vectors based on the first representation sub-vectors, the target weight matrix, and the target convolution kernel in the following manner: performing an element-wise multiplication operation on the vertical attention weight matrix, the horizontal attention weight matrix, and the first representation sub-vectors, and combining a result of the element-wise multiplication operation with the first representation sub-vectors to obtain third representation sub-vectors; and performing a convolution operation on the third representation sub-vectors by using the target convolution kernel to obtain the second representation sub-vectors.

In a solution, the apparatus is further configured to: perform a global average pooling operation on the second representation vector to obtain a global representation vector with a compressed spatial dimension; divide the global representation vector into a first global representation sub-vector and a second global representation sub-vector, where the first global representation sub-vector is configured for representing a video snippet corresponding to the second representation vector, and the second global representation sub-vector is configured for representing interaction information between the video snippet corresponding to the second representation vector and an adjacent video snippet; and determine the inter-snippet representation vector based on the global representation vector, the first global representation sub-vector, and the second global representation sub-vector.

In a solution, the apparatus is configured to divide the global representation vector into the first global representation sub-vector and the second global representation sub-vector in the following manner: performing a convolution operation on the global representation vector by using a first convolution kernel to obtain a global representation vector with a reduced dimension; performing a normalization operation on the global representation vector with a reduced dimension to obtain a normalized global representation vector; performing a deconvolution operation on the normalized global representation vector by using a second convolution kernel to obtain the first global representation sub-vector with a same dimension as the global representation vector; performing a bidirectional temporal difference operation on the global representation vector to determine a second difference matrix and a third difference matrix between the video snippet corresponding to the second representation vector and the adjacent video snippet; and generating the second global representation sub-vector based on the second difference matrix and the third difference matrix.

In a solution, the apparatus is configured to determine the inter-snippet representation vector based on the global representation vector, the first global representation sub-vector, and the second global representation sub-vector in the following manner: performing an element-wise multiplication operation on the first global representation sub-vector, the second global representation sub-vector, and the global representation vector, and combining a result of the element-wise multiplication operation with the global representation vector to obtain a third global representation sub-vector; and performing a convolution operation on the third global representation sub-vector by using a third convolution kernel to determine the inter-snippet representation vector.

For the apparatus in the foregoing embodiments, specific manners in which the modules perform operations have been described in detail in the embodiments related to the method, and details are not described herein.

According to still another aspect of the embodiments of this disclosure, a video detection model is further provided, including: an extraction module, configured to extract N video snippets from a to-be-processed video, where each video snippet in the N video snippets includes M frames of images, the N video snippets include a to-be-recognized initial object, and both N and M are positive integers greater than or equal to 2; and a target neural network model, configured to obtain a target recognition result based on the inputted N video snippets, where the target recognition result represents a probability that the initial object is an edited object, the target neural network model includes a target backbone network and a target classification network, the target backbone network is configured to determine a target representation vector of the N video snippets based on the inputted N video snippets, and the target classification network is configured to determine the target recognition result based on the target representation vector. The target backbone network includes an intra-snippet recognition module and an inter-snippet recognition module, the intra-snippet recognition module is configured to determine an intra-snippet representation vector based on a first representation vector inputted to the intra-snippet recognition module, the first representation vector is an intermediate representation vector corresponding to each video snippet in the N video snippets, the intra-snippet representation vector is configured for representing inconsistent information between frames of images in cach video snippet in the N video snippets, the inter-snippet recognition module is configured to determine an inter-snippet representation vector based on a second representation vector inputted to the inter-snippet recognition module, the second representation vector is an intermediate representation vector corresponding to each video snippet in the N video snippets, the inter-snippet representation vector is configured for representing inconsistent information between the N video snippets, and the target representation vector is a representation vector determined based on the intra-snippet representation vector and the inter-snippet representation vector.

In a solution, the model further includes: an obtaining module, configured to obtain original representation vectors of the N video snippets; a first network structure, configured to determine the first representation vector inputted to the intra-snippet recognition module based on the original representation vectors; the intra-snippet recognition module, configured to determine the intra-snippet representation vector based on the first representation vector; a second network structure, configured to determine the second representation vector inputted to the inter-snippet recognition module based on the original representation vectors; the inter-snippet recognition module, configured to determine the inter-snippet representation vector based on the second representation vector; and a third network structure, configured to determine the target representation vector based on the intra-snippet representation vector and the inter-snippet representation vector.

In a solution, the target backbone network includes: the intra-snippet recognition module and the inter-snippet recognition module that are alternately placed.

For the model in the foregoing embodiments, specific manners in which the modules and the network structures perform operations have been described in detail in the embodiments related to the method, and details are not described herein.

According to an aspect of this disclosure, a computer program product is provided. The computer program product includes a computer program/instructions, and the computer program/instructions include program code configured for performing the methods shown in the flowcharts. In such an embodiment, the computer program may be downloaded and installed from a network through a communication part 1109, and/or installed from a removable medium 1111. When the computer program is executed by a central processing unit 1101, various functions provided in the embodiments of this disclosure are executed.

The sequence numbers of the foregoing embodiments of this disclosure are merely for description purpose, and do not indicate the preference among the embodiments.

FIG. 11 is a schematic structural block diagram of a computer system configured to implement an electronic device according to an embodiment of this disclosure.

The computer system 1100 of the electronic device shown in FIG. 11 is merely an example, and does not constitute any limitation on functions and use ranges of the embodiments of this disclosure.

As shown in FIG. 11, the computer system 1100 includes a central processing unit (CPU) 1101. The CPU 1101 may perform various appropriate actions and processing according to a program stored in a read-only memory (ROM) 1102 or a program loaded from a storage part 1108 into a random access memory (RAM) 1103. The RAM 1103 further stores various programs and data required for system operations. The CPU 1101, the ROM 1102, and the RAM 1103 are connected to each other through a bus 1104. An input/output (I/O) interface 1105 is also connected to the bus 1104.

The following components are connected to the I/O interface 1105: an input part 1106 including a keyboard, a mouse, or the like; an output part 1107 including a cathode ray tube (CRT), a liquid crystal display (LCD), a speaker, or the like; a storage part 1108 including a hard disk or the like; and a communication part 1109 including a network interface card such as a local area network card, a modem, or the like. The communication part 1109 performs communication processing by using a network such as the Internet. A driver 1110 is also connected to the I/O interface 1105 as required. The removable medium 1111, such as a magnetic disk, an optical disc, a magneto-optical disk, or a semiconductor memory, is installed on the driver 1110 as required, so that a computer program read from the removable medium is installed into the storage part 1108 as required.

Particularly, according to an embodiment of this disclosure, the processes described in the method flowcharts may be implemented as computer software programs. For example, an embodiment of this disclosure includes a computer program product, the computer program product includes a computer program carried on a computer-readable medium, and the computer program includes program code configured for performing the methods shown in the flowcharts. In such an embodiment, the computer program may be downloaded and installed from a network through the communication part 1109, and/or installed from the removable medium 1111. When the computer program is executed by the CPU 1101, the various functions defined in the system of this disclosure are executed.

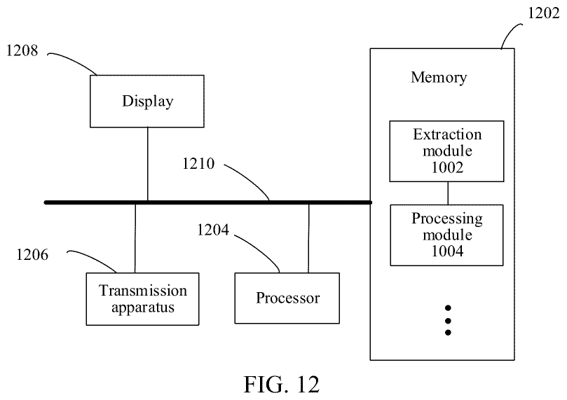

According to still another aspect of the embodiments of this disclosure, an electronic device for implementing the foregoing video detection method is further provided. The electronic device may be the terminal device or the server shown in FIG. 1. In this embodiment, an example in which the electronic device is a terminal device is used for description. As shown in FIG. 12, the electronic device includes a memory 1202 (non-transitory computer-readable storage medium) and a processor 1204 (processing circuitry). The memory 1202 stores a computer program. The processor 1204 is configured to perform the steps in any one of the foregoing method embodiments through the computer program.

In this embodiment, the foregoing electronic device may be located in at least one of a plurality of network devices in a computer network.

In this embodiment, the processor may be configured to perform the following steps through the computer program.
S1: Extract N video snippets from a to-be-processed video, where each video snippet in the N video snippets includes M frames of images, the N video snippets include a to-be-recognized initial object, and both N and M are positive integers greater than or equal to 2.
S2: Determine a target representation vector of the N video snippets based on the N video snippets, and determine a target recognition result based on the target representation vector, where the target recognition result represents a probability that the initial object is an edited object.

The target representation vector is a representation vector determined based on an intra-snippet representation vector and an inter-snippet representation vector, the intra-snippet representation vector is determined by a first representation vector, the first representation vector is an intermediate representation vector corresponding to each video snippet in the N video snippets, the intra-snippet representation vector is configured for representing inconsistent information between frames of images in each video snippet in the N video snippets, the inter-snippet representation vector is determined by a second representation vector, the second representation vector is an intermediate representation vector corresponding to each video snippet in the N video snippets, and the inter-snippet representation vector is configured for representing inconsistent information between the N video snippets.

A person of ordinary skill in the art may understand that, the structure shown in FIG. 12 is only schematic. Alternatively, the electronic device may be a terminal device such as a smartphone (such as an Android phone or an iOS phone), a tablet computer, a palmtop computer, a mobile Internet device (MID), or a PAD. FIG. 12 does not limit the structure of the foregoing electronic device. For example, the electronic device may further include more or fewer components (such as a network interface) than those shown in FIG. 12, or have a configuration different from that shown in FIG. 12.

The memory 1202 may be configured to store a software program and a module, for example, a program instruction/module corresponding to the video detection method and apparatus in the embodiments of this disclosure, and the processor 1204 performs various functional applications and data processing by running the software program and the module stored in the memory 1202, that is, implementing the foregoing video detection method. The memory 1202 may include a high-speed RAM, and may further include a non-volatile memory such as one or more magnetic storage apparatuses, a flash memory, or another non-volatile solid-state memory. In some embodiments, the memory 1202 may further include memories remotely disposed relative to the processor 1204, and these remote memories may be connected to a terminal through a network. Examples of the network include, but not limited to, the Internet, an intranet, a local area network, a mobile communication network, and a combination thereof. The memory 1202 may be specifically configured to, but not limited to, store information such as video snippets. As an example, as shown in FIG. 12, the foregoing memory 1202 may include, but not limited to, the extraction module 1002 and the processing module 1004 in the foregoing video detection apparatus. In addition, the memory may further include, but not limited to, other modules and units in the foregoing video detection apparatus, and details are not described herein again in this example.

A transmission apparatus 1206 is configured to receive or transmit data through a network. Specific examples of the network include a wired network and a wireless network. In an example, the transmission apparatus 1206 includes a network interface controller (NIC). The NIC may be connected to another network device and a router by using a network cable, to communicate with the Internet or a local area network. In an example, the transmission apparatus 1206 is a radio frequency (RF) module, and is configured to wirelessly communicate with the Internet.

In addition, the foregoing electronic device may further include: a display 1208, configured to display the foregoing to-be-processed video; and a connection bus 1210, configured to connect various module components in the electronic device.

In other embodiments, the foregoing terminal device or server may be a node in a distributed system. The distributed system may be a blockchain system. The blockchain system may be a distributed system formed by a plurality of nodes connected in the form of network communication. A peer to peer (P2P) network may be formed between the nodes. A computing device in any form, for example, an electronic device such as a server or a terminal, may become a node in the blockchain system by joining the P2P network.

According to an aspect of this disclosure, a non-transitory computer-readable storage medium is provided. A processor of a computer device reads computer instructions from the computer-readable storage medium, and executes the computer instructions, so that the computer device performs the video detection method provided in the various implementations in the foregoing video detection aspects.

In this embodiment, the foregoing computer-readable storage medium may be configured to store a computer program configured for performing the following steps:
S1: Extract N video snippets from a to-be-processed video, where each video snippet in the N video snippets includes M frames of images, the N video snippets include a to-be-recognized initial object, and both N and M are positive integers greater than or equal to 2.
S2: Determine a target representation vector of the N video snippets based on the N video snippets, and determine a target recognition result based on the target representation vector, where the target recognition result represents a probability that the initial object is an edited object.

The target representation vector is a representation vector determined based on an intra-snippet representation vector and an inter-snippet representation vector, the intra-snippet representation vector is determined by a first representation vector, the first representation vector is an intermediate representation vector corresponding to each video snippet in the N video snippets, the intra-snippet representation vector is configured for representing inconsistent information between frames of images in each video snippet in the N video snippets, the inter-snippet representation vector is determined by a second representation vector, the second representation vector is an intermediate representation vector corresponding to each video snippet in the N video snippets, and the inter-snippet representation vector is configured for representing inconsistent information between the N video snippets.

In this embodiment, a person of ordinary skill in the art may understand that all or some of the steps of the various methods in the foregoing embodiments may be implemented by a program instructing relevant hardware of the terminal device. The program may be stored in a computer-readable storage medium. The storage medium may include: a flash drive, a read-only memory (ROM), a random access memory (RAM), a magnetic disk, an optical disc, or the like.

The sequence numbers of the foregoing embodiments of this disclosure are merely for description purpose, and do not indicate the preference among the embodiments.

When the integrated unit in the foregoing embodiments is implemented in the form of a software function unit and sold or used as an independent product, the integrated unit may be stored in the foregoing computer-readable storage medium. Based on such an understanding, the technical solutions of this disclosure essentially, or a part contributing to the related art, or all or a part of the technical solution may be implemented in a form of a software product. The computer software product is stored in a storage medium and includes several instructions for instructing one or more computer devices (which may be a personal computer, a server, a network device, or the like) to perform all or some of steps of the methods in the embodiments of this disclosure.

In the foregoing embodiments of this disclosure, the descriptions of the embodiments have respective focuses. For a part that is not described in detail in an embodiment, reference may be made to related descriptions in other embodiments.

In the several embodiments provided in this disclosure, it is to be understood that a disclosed client may be implemented in other manners. The described apparatus embodiments are merely exemplary. For example, the unit division is merely logical function division and there may be other division manners during actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the units or modules may be implemented in an electronic form or another form.

The units described as separate parts may or may not be physically separate, and parts displayed as units may or may not be physical units, in other words, may be located at one position, or may be distributed on a plurality of network units. Some or all of the units may be selected based on actual requirements to achieve the objectives of the solutions of the embodiments.

The term module (and other similar terms such as unit, submodule, etc.) in this disclosure may refer to a software module, a hardware module, or a combination thereof. A software module (e.g., computer program) may be developed using a computer programming language. A hardware module may be implemented using processing circuitry and/or memory. Each module can be implemented using one or more processors (or processors and memory). Likewise, a processor (or processors and memory) can be used to implement one or more modules. Moreover, each module can be part of an overall module that includes the functionalities of the module.

The foregoing disclosure includes some exemplary embodiments of this disclosure which are not intended to limit the scope of this disclosure. Other embodiments shall also fall within the scope of this disclosure.

What is claimed is:

1. A video detection method, comprising:
extracting N video snippets from a video, each video snippet of the N video snippets comprising M frames, the N video snippets comprising an initial object, and both N and M being positive integers greater than or equal to 2; and
determining a representation vector of the N video snippets, and determining a recognition result based on the representation vector, the recognition result representing a probability that the initial object is an edited object, wherein
the representation vector is determined based on intra-snippet representation vectors and inter-snippet representation vectors, each intra-snippet representation vector corresponding to a respective video snippet of the N video snippets and representing inconsistent information between frames in the respective video snippet of the N video snippets, and each inter-snippet representation vector corresponding to a respective video snippet of the N video snippets and representing inconsistent information between the respective video snippet and one or more adjacent video snippets of the N video snippets.

2. The method according to claim 1, wherein the method further comprises:
dividing a first representation vector corresponding to the respective video snippet of the N video snippets along a channel dimension to obtain first representation sub-vectors;
determining a convolution kernel based on the first representation sub-vectors, wherein the convolution kernel is a convolution kernel corresponding to the first representation vector;
determining a weight matrix corresponding to the first representation sub-vectors, wherein the weight matrix is configured for extracting motion information between adjacent frames based on an attention mechanism;
determining second representation sub-vectors based on the first representation sub-vectors, the weight matrix, and the convolution kernel; and
splicing the first representation sub-vectors and the second representation sub-vectors into the intra-snippet representation vector corresponding to the respective video snippet of the N video snippets.

3. The method according to claim 2, wherein the determining the convolution kernel based on the first representation sub-vectors comprises:
performing a global average pooling operation on each of the first representation sub-vectors to obtain respective first representation sub-vectors with a compressed spatial dimension;
performing a fully connected operation on the first representation sub-vectors with the compressed spatial dimension to determine an initial convolution kernel; and
performing a normalization operation on the initial convolution kernel to obtain the convolution kernel.

4. The method according to claim 2, wherein the determining the weight matrix corresponding to the first representation sub-vectors comprises:
performing a bidirectional temporal difference operation on the first representation sub-vectors to determine a first difference matrix between adjacent frames in the respective video snippet corresponding to the first representation vector;
reshaping the first difference matrix into a horizontal inconsistency parameter matrix and a vertical inconsistency parameter matrix along a horizontal dimension and a vertical dimension respectively; and
determining a vertical attention weight matrix and a horizontal attention weight matrix based on the horizontal inconsistency parameter matrix and the vertical inconsistency parameter matrix respectively, wherein the weight matrix comprises the vertical attention weight matrix and the horizontal attention weight matrix.

5. The method according to claim 4, wherein the determining the second representation sub-vectors based on the first representation sub-vectors, the weight matrix, and the convolution kernel comprises:
performing an element-wise multiplication operation on the vertical attention weight matrix, the horizontal attention weight matrix, and the first representation sub-vectors, and combining a result of the element-wise multiplication operation with the first representation sub-vectors to obtain third representation sub-vectors; and
performing a convolution operation on the third representation sub-vectors by using the convolution kernel to obtain the second representation sub-vectors.

6. The method according to claim 1, wherein the method further comprises:
performing a global average pooling operation on a second representation vector corresponding to the respective video snippet of the N video snippets to obtain a global representation vector with a compressed spatial dimension;
dividing the global representation vector into a first global representation sub-vector and a second global representation sub-vector, wherein the first global representation sub-vector represents the respective video snippet corresponding to the second representation vector, and the second global representation sub-vector represents interaction information between the respective video snippet corresponding to the second representation vector and at least one adjacent video snippet; and
determining the inter-snippet representation vector for the respective video snippet based on the global representation vector, the first global representation sub-vector, and the second global representation sub-vector.

7. The method according to claim 6, wherein the dividing the global representation vector comprises:
performing a convolution operation on the global representation vector by using a first convolution kernel to obtain a global representation vector with a reduced dimension;
performing a normalization operation on the global representation vector with the reduced dimension to obtain a normalized global representation vector;
performing a deconvolution operation on the normalized global representation vector by using a second convolution kernel to obtain the first global representation sub-vector with a same dimension as the global representation vector;
performing a bidirectional temporal difference operation on the global representation vector to determine a second difference matrix and a third difference matrix between the respective video snippet corresponding to the second representation vector and adjacent video snippets; and
generating the second global representation sub-vector based on the second difference matrix and the third difference matrix.

8. The method according to claim 6, wherein the determining the inter-snippet representation vector for the respective video snippet based on the global representation vector, the first global representation sub-vector, and the second global representation sub-vector comprises:
performing an element-wise multiplication operation on the first global representation sub-vector, the second global representation sub-vector, and the global representation vector, and combining a result of the element-wise multiplication operation with the global representation vector to obtain a third global representation sub-vector; and
performing a convolution operation on the third global representation sub-vector by using a third convolution kernel to obtain the inter-snippet representation vector for the respective video snippet.

9. A video detection apparatus, comprising:
processing circuitry configured to
extract N video snippets from a video, each video snippet of the N video snippets comprising M frames, the N video snippets comprising an initial object, and both N and M being positive integers greater than or equal to 2; and
determine a representation vector of the N video snippets, and determine a target recognition result based on the representation vector, the recognition result representing a probability that the initial object is an edited object, wherein
the representation vector is determined based on intra-snippet representation vectors and inter-snippet representation vectors, each intra-snippet representation vector corresponding to a respective video snippet of the N video snippets and representing inconsistent information between frames in the respective video snippet of the N video snippets, and each inter-snippet representation vector corresponding to a respective video snippet of the N video snippets and representing inconsistent information between the respective video snippet and one or more adjacent video snippets of the N video snippets.

10. A video detection apparatus, comprising:
processing circuitry configured to extract N video snippets from a video, each video snippet of the N video snippets comprising M frames, the N video snippets comprising an initial object, and both N and M being positive integers greater than or equal to 2; and
a neural network model, configured to obtain a recognition result based on the N video snippets, the recognition result representing a probability that the initial object is an edited object, the neural network model comprising a backbone network and a classification network, the backbone network being configured to determine a representation vector of the N video snippets, and the classification network being configured to determine the recognition result based on the representation vector, wherein
the backbone network comprises an intra-snippet recognition module and an inter-snippet recognition module, the intra-snippet recognition module being configured to determine intra-snippet representation vectors, each corresponding to a respective video snippet of the N video snippets and representing inconsistent information between frames in the respective video snippet of the N video snippets, and the inter-snippet recognition module being configured to determine inter-snippet representation vectors, each corresponding to a respective video snippet of the N video snippets and representing inconsistent information between the respective video snippet and one or more adjacent video snippets of the N video snippets, and the representation vector being based on the intra-snippet representation vectors and the inter-snippet representation vectors.

11. The apparatus according to claim 10, wherein the model further comprises:
processing circuitry configured to obtain original representation vectors of the N video snippets;
a first network structure, configured to determine a first representation vector corresponding to the respective video snippet of the N video snippets inputted to the intra-snippet recognition module based on the original representation vectors;
the intra-snippet recognition module, configured to determine an intra-snippet representation vector based on the first representation vector;
a second network structure, configured to determine a second representation vector corresponding to the respective video snippet of the N video snippets inputted to the inter-snippet recognition module based on the original representation vectors;
the inter-snippet recognition module, configured to determine an inter-snippet representation vector based on the second representation vector; and
a third network structure, configured to determine the representation vector based on the intra-snippet representation vector and the inter-snippet representation vector.

12. The apparatus according to claim 10, wherein the backbone network comprises:
plural intra-snippet recognition modules and inter-snippet recognition module that are alternately placed.

13. A computer-readable storage medium storing computer-readable instructions thereon, which, when executed by a computer, cause the computer to implement the method according to claim 1.

14. The apparatus according to claim 10, wherein the neural network model is further configured to:
divide a first representation vector corresponding to the respective video snippet of the N video snippets along a channel dimension to obtain first representation sub-vectors;
determine a convolution kernel based on the first representation sub-vectors, wherein the convolution kernel is a convolution kernel corresponding to the first representation vector;
determine a weight matrix corresponding to the first representation sub-vectors, wherein the weight matrix is configured for extracting motion information between adjacent frames based on an attention mechanism;
determine second representation sub-vectors based on the first representation sub-vectors, the weight matrix, and the convolution kernel; and
splice the first representation sub-vectors and the second representation sub-vectors into the intra-snippet representation vector corresponding to the respective video snippet of the N video snippets.

15. The apparatus according to claim 14, wherein the neural network model is further configured to:
perform a global average pooling operation on each of the first representation sub-vectors to obtain respective first representation sub-vectors with a compressed spatial dimension;
perform a fully connected operation on the first representation sub-vectors with the compressed spatial dimension to determine an initial convolution kernel; and
perform a normalization operation on the initial convolution kernel to obtain the convolution kernel.

16. The apparatus according to claim 14, wherein the neural network model is further configured to:
perform a bidirectional temporal difference operation on the first representation sub-vectors to determine a first difference matrix between adjacent frames in the respective video snippet corresponding to the first representation vector;
reshape the first difference matrix into a horizontal inconsistency parameter matrix and a vertical inconsistency parameter matrix along a horizontal dimension and a vertical dimension respectively; and
determine a vertical attention weight matrix and a horizontal attention weight matrix based on the horizontal inconsistency parameter matrix and the vertical inconsistency parameter matrix respectively, wherein the weight matrix comprises the vertical attention weight matrix and the horizontal attention weight matrix.

17. The apparatus according to claim 16, wherein the neural network model is further configured to:
perform an element-wise multiplication operation on the vertical attention weight matrix, the horizontal attention weight matrix, and the first representation sub-vectors, and combine a result of the element-wise multiplication operation with the first representation sub-vectors to obtain third representation sub-vectors; and
perform a convolution operation on the third representation sub-vectors by using the convolution kernel to obtain the second representation sub-vectors.

18. The apparatus according to claim 10, wherein the neural network model is further configured to:
perform a global average pooling operation on a second representation vector corresponding to the respective video snippet of the N video snippets to obtain a global representation vector with a compressed spatial dimension;
divide the global representation vector into a first global representation sub-vector and a second global representation sub-vector, wherein the first global representation sub-vector represents the respective video snippet corresponding to the second representation vector, and the second global representation sub-vector represents interaction information between the respective video snippet corresponding to the second representation vector and at least one adjacent video snippet; and
determine the inter-snippet representation vector for the respective video snippet based on the global representation vector, the first global representation sub-vector, and the second global representation sub-vector.

19. The apparatus according to claim 18, wherein the neural network model is further configured to:
perform a convolution operation on the global representation vector by using a first convolution kernel to obtain a global representation vector with a reduced dimension;
perform a normalization operation on the global representation vector with the reduced dimension to obtain a normalized global representation vector;
perform a deconvolution operation on the normalized global representation vector by using a second convolution kernel to obtain the first global representation sub-vector with a same dimension as the global representation vector;
perform a bidirectional temporal difference operation on the global representation vector to determine a second difference matrix and a third difference matrix between the respective video snippet corresponding to the second representation vector and adjacent video snippets; and
generate the second global representation sub-vector based on the second difference matrix and the third difference matrix.

20. The apparatus according to claim 18, wherein the neural network model is further configured to:
perform an element-wise multiplication operation on the first global representation sub-vector, the second global representation sub-vector, and the global representation vector, and combine a result of the element-wise multiplication operation with the global representation vector to obtain a third global representation sub-vector; and
perform a convolution operation on the third global representation sub-vector by using a third convolution kernel to obtain the inter-snippet representation vector for the respective video snippet.
